(19) United States
(12) Patent Application Publication
(10) Pub. No.: US 2007/0067512 A1
(43) Pub. Date: Mar. 22, 2007

(54) Method, system and software arrangement for processing a device support file for a field device

(75) Inventors: Omar Sacilotto Donaires, Ribeirao Preto (BR); Rodrigo Palucci Pantoni, Ribeirao Preto (BR); Eugenio Ferreira Da Silva Neto, Biel-Benken (CH)

Correspondence Address: DORSEY & WHITNEY LLP;INTELLECTUAL PROPERTY DEPARTMENT, 250 PARK AVENUE, NEW YORK, NY, 10177, US

(73) Assignees: Smar Research Corporation; EndressProcess Solutions AG

(21) Appl. No.: 11/231,060

(22) Filed: Sep. 19, 2005

(51) Int. Cl. G06F 13/38

(52) U.S. Cl. 710/62

(57) ABSTRACT

A method, system computer-readable medium and software arrangement are provided for processing a device support file for a field device, such as a Foundation™ Fieldbus device. A device support file can be installed on a processing arrangement. The device support file may be received, for example, from a remote computer system. In one exemplary embodiment, a configuration file may be opened and reviewed to identify any missing device support files, and the missing files may be obtained automatically from the remote computer system. Upon the installation, a capabilities file of the device support file may be validated by comparing the capabilities file with common (previously obtained) rules generally associated with the capabilities file. In one further exemplary embodiment, the capabilities file may be validated by performing a consistency check of the retrieved capabilities file with a current version of the common rules.

### FIELD OF INVENTION

The present invention relates to field devices connected to a computer system. More particularly, the present invention relates to device support software arrangement, system and method used in connection with field devices capable of updating field device support software at the computer system associated with a field device.

### BACKGROUND INFORMATION

In the field of computer software and hardware, and particularly with those systems using the “Foundation™ Fieldbus” or similar standards, it may be desirable to maintain accurate information in device support files associated with the field devices. Device Support files are important for the operation of a Foundation™ Fieldbus system, and likely responsible for interoperability and extensibility of a Foundation™ Fieldbus system. Device Support files include device descriptions and capabilities files for a particular Foundation™ Fieldbus device. Conventional systems and methods allow a usage of device descriptions and capabilities files from a specific source into a system by copying these files or modifying content of such files to fit into the system's architecture.

The conventional use of the Foundation™ Fieldbus Device Support files has various problems that make installation and maintenance of the Device Support files difficult and time consuming for the user. First, the conventional Device Support files are generally installed according to Foundation™ Fieldbus rules, using manufacturer and device type codes. Foundation™ Fieldbus rules may change from time to time, so conventional copying of Device Support files may install an older, outdated version thereof. This is particularly problematic where Device Support files are manually copied from one environment to another, or manually packed and transmitted, for example, by email or otherwise over a computer network, to a remote computer. Secondly, a capabilities file can be generated through an ordinary text editor, which may be prone to inconsistencies and tampering. As a result, the capabilities files may have inconsistencies that can present problems to the system's functionality and behavior, which may cause the user to make mistakes by integrating incompatible devices into the system.

Regardless of the cause, missing or inconsistent Device Support files usually can cause problems for the users. Foundation™ Fieldbus applications generally rely on the information in the Device Support files to handle the operation of the devices. In a large application, for example, the user may obtain a missing Device Support file only when such user attempts to work with the device associated with such Device Support file. During the time when the user is performing a critical operation, a detection of the missing Device Support file can prevent the completion of the operation which may be critical.

### SUMMARY OF THE INVENTION

Accordingly, there exists a need to provide an improved method, system and software arrangement for processing device support files which overcome at least some of the above-referenced deficiencies. Accordingly, at least this and other needs have been addressed by exemplary embodiments of the method, system and software arrangement according to the present invention. One such exemplary embodiment is directed to a method for processing a device support file for a field device. A device support file can be installed on a computer system. Upon the installation of the device capabilities file, the device support file can be validated by comparing the capabilities file with common rules generally associated with the capabilities file.

In another exemplary embodiment of the present invention, a computer system is provided having a processor and a storage arrangement (e.g., memory, hard drive, floppy disk, CD-ROM, on Internet or any other storage medium). The storage arrangement has stored thereon computer-executable instructions for processing a device support file for a field device. In this exemplary method a device support file is installed on a computer system. Then, upon the installation of the device support file, a capabilities file of the device support file is validated by comparing the capabilities file with common rules associated with the capabilities file. In yet another exemplary embodiment of the present invention, a computer-readable medium is provided having stored thereon computer-executable instructions for processing a device support file for a field device as described herein above for the system and method. A software arrangement can also be provided in accordance with the present invention, which can program a processing arrangement to execute these functions.

### BRIEF DESCRIPTION OF DRAWINGS

The detailed description will refer to the following drawings, wherein like numerals refer to like elements, and wherein:

FIG. 1 shows a block diagram of an exemplary embodiment of a computer system according to the present invention that includes a local system connected to a remote system across a network;

FIG. 2 shows a flow diagram of one exemplary embodiment of a method of importing device support to a local system according to the present invention;

FIG. 3 shows a block diagram of the system shown in FIG. 1, illustrating an exemplary process according to the present invention for updating existing device support files;

FIG. 4 shows a flow diagram of a method according to another exemplary embodiment of the present invention for a verifying device support files that are transferred between systems;

FIG. 5 shows a block diagram of two interconnected computer systems according to yet another exemplary embodiment of the present invention; and

FIG. 6 shows a flow diagram of still another exemplary embodiment of a method of processing the device support files sent from a source system to a destination system, as shown in FIG. 5.

### DETAILED DESCRIPTION

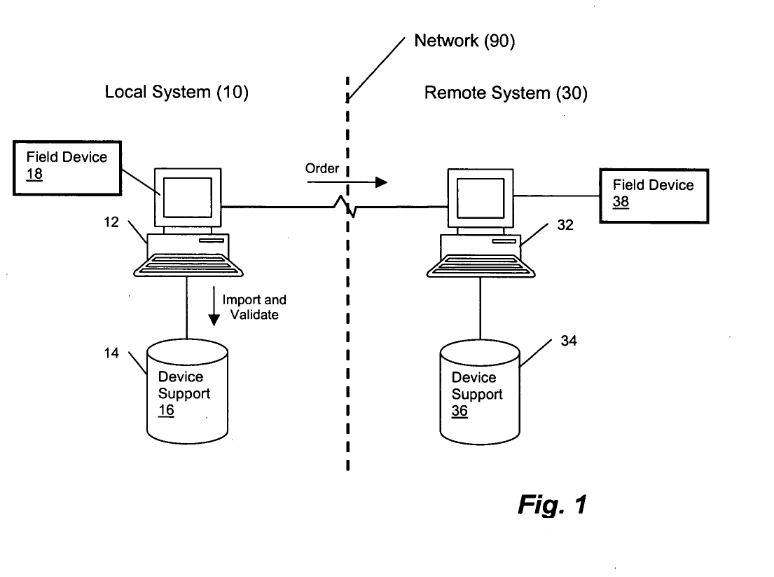

FIG. 1 shows a block diagram of an exemplary embodiment of a computer system according to the present invention which includes a local system 10 connected to a remote system 30 across a network 90 or another communications arrangement. Each of the local system 10 and the remote system 30 include a respective terminal 12, 32 connected to a respective storage arrangement 14, 34 (e.g., memory, hard drive, CD-ROM, floppy disk, memory stick, Internet, etc.). The storage arrangements 14, 34 can store device support files 16, 36 that are used to support one or more field devices 18, 38 associated with the respective computer systems 10, 30. In one exemplary embodiment of the present invention, the device support file 16 can include device descriptions (“DD”) and capabilities files (“CF”) associated with the field device 18. In one further exemplary embodiment of the present invention, the field devices 18, 38 “Fieldbus” devices utilize the Foundation™ Fieldbus standards. Fieldbus device support files generally use a standard file structure for device descriptions and capabilities files. Also, Foundation™ Fieldbus file names generally relate to device revision and device description revision which use two-digit entries followed by a file extension. For example, the file 0101.ffo refers to the first device version (01), and the first device description revision (01) of a .ffo file (a binary DD file).

The computer systems 10, 30 can be extendable. For example, when a new field device (e.g., field device 18) is introduced (or connected) to the system 10, or when a field device revision is introduced to the system 10, it is possible that the corresponding device support data may not yet be installed in the storage arrangement 14 of the system 10. If this occurs, the user can install the current device support files 16 into the storage arrangement 14 associated with the local system 10. The device support files 16 can be provided on a disc or other tangible medium or, as illustrated in FIG. 1, may be obtained from a remote computer system 30 connected to the local system 10 by a network 90, such as the Internet. Certain device support files are available from a central source via the Internet or another communications network. In one example of a Foundation™ Fieldbus device, device support files may be available from the Foundation™ Fieldbus via the Internet.

In the exemplary embodiment of the systems illustrated in FIG. 1, the device support files 16 can be identified on-line, and obtained (e.g., ordered) from the remote computer system 30. Copies of the device support files 16 can be transmitted via the network 90 to the local system 10, and stored in the storage arrangement 14. The transmission of the device support files 16 from the remote system 30 to the local system 10, and the installation of the support files 16 can be performed in a manner that is transparent to the user of the local system 10 by taking advantage of the known file structure of the device support files 16.

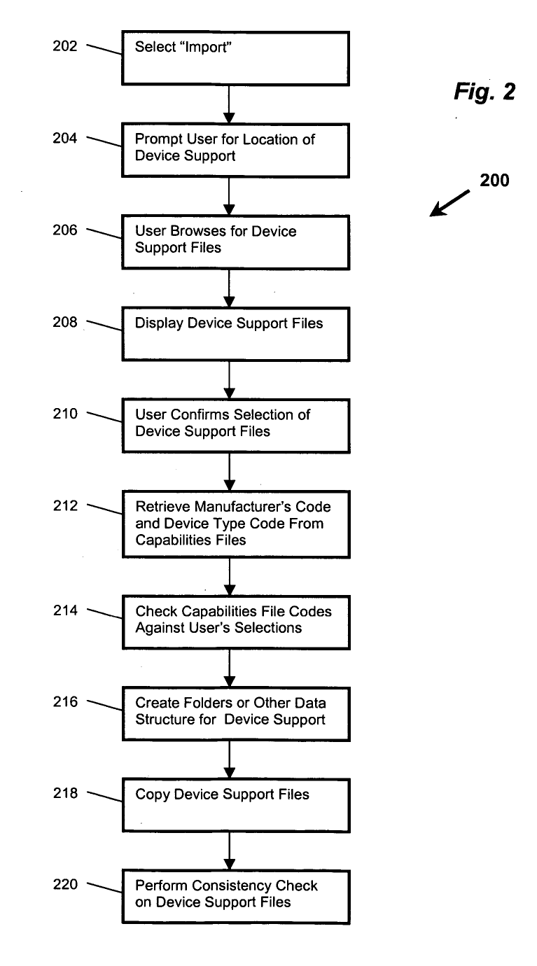

FIG. 2 shows a flow diagram of one exemplary embodiment of a method 200 according to the present invention for importing device support to a local system 10. For example, a file structure can be created so that the imported device support files 16 may be matched to a standardized file structure that is generally used by the device support files 16. During the importation, in step 202, the user may select an import option from a graphical user interface (“GUI”) displayed on the local terminal 12 to import a particular device support for a new device type or a revision to an existing device type. In step 204, the local system 10 prompts the user to enter a source location of the device support files 16. Using a browser or another arrangement, the user browses for device support files 16 to obtain the new device type or device type revision (step 206). The device support files 16 may be located, for example, on a remote system 30, in one exemplary embodiment.

In step 208, the local system 10 identifies device support files 16, e.g., by their file extensions, and displays a list of available device support files 16. The file names can be converted to simplify the import process for the user. The list indicates the files by, e.g., the manufacturer name and device type name, instead of, or in addition to displaying numeric codes associated with the device support files 16. In step 210, the user confirms the selection of the device support files 16 using the GUI. In step 212, the local system 10 then retrieves the manufacturer's codes from the capabilities files, and utilizes these codes to verify 214 that the files 16 and the file locations selected by the user are valid.

The local system 10 can create file folders or other data structures in the storage arrangement 14 for the device support files 16 in step 216. The device support files 16 are then placed into the data structures provided in the storage arrangement 14 in step 218. When the files 16 are placed into the data structure 14, a capabilities file consistency check can be performed in step 220 on the files 16 to ensure or verify that the copied files 16 do not have any inconsistent definitions (or possess only a limited number thereof) that could harm the system 10 or otherwise disrupt the operation of the system.

In one exemplary embodiment of the method according to the present invention, the performance of the consistency check is optional to the user. If such check is performed in step 220, it can be done in two different ways. As a first option, e.g., only the information that is actually used by the system 10 is checked or verified. For example, the device support files 16 for a particular device may still be imported even if there is some inconsistency in the information that is not currently used by the system 10. As a second option, the capabilities files can be completely checked or verified according to standards, such as the FF-103 standard currently being used in connection with the Foundation™ Fieldbus devices. If any information is determined to be inconsistent, then the device support files 16 for the device may possibly not be imported, even if the inconsistencies are found in the information that is not currently used by the system 10.

When a new version of the consistency check utility is installed in the system 10, it is possible that the consistency rules may have changed. For example, the changes may have been implemented to fix or address various problems, add new rules, and/or remove obsolete rules based on the evolution of the standard specifications. For these reasons, e.g., when a new version of the consistency check utility is installed, all device support files 16 in the storage arrangement 14 may preferably be checked again to determine whether the device support files comply with the new consistency rules, either completely or to a large degree. In one exemplary embodiment of the present invention, the two options for consistency checking described herein may also apply. The consistency check may be performed, e.g., only on the information presently utilized by the system 10 and/or on all information regardless of whether the information is currently used by the system 10.

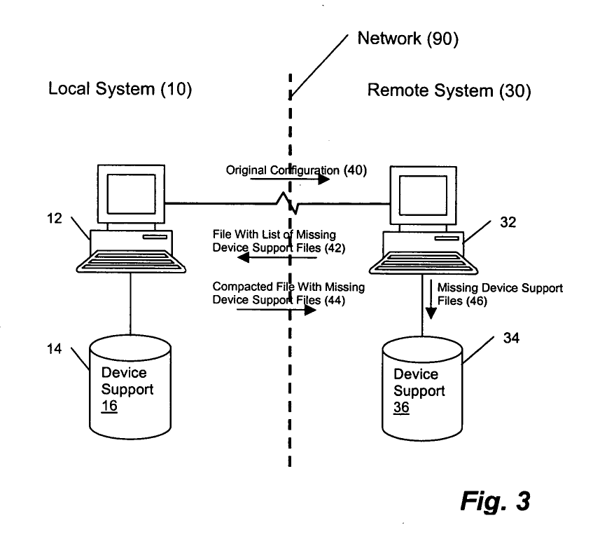

FIG. 3 shows a block diagram of another exemplary embodiment of the systems 10, 30 shown in FIG. 1 that are interconnected to one another, illustrating an exemplary process for updating the existing device support files 16. Field devices generally rely on the device support for functionality. At times, the device support files 16 may have to be transmitted from one system (e.g., system 10) to another system (e.g., system 30). As shown in FIG. 3, the local system 10 can be the source system, and the remote system 30 can be the destination system. The device support may be forwarded from the source system 10 to the destination system 30 as described herein. The device support is thus dynamic in that the user can extend the device support to introduce new types of devices. For this reason, it is possible that the device support at the destination system (e.g., system 30) is not exactly the same as the device support at the original system (e.g., system 10). Particularly in a large application, the user may not necessarily discover that device support is missing until the user attempts to operate or communicate with a field device for which the device support is missing. For example, in conventional systems, this can prevent the application from properly operating. In this exemplary embodiment of the present invention, the device support files can be verified for missing or damaged files during the transfer of the files between one system (e.g., system 10) and another system (e.g., system 30).

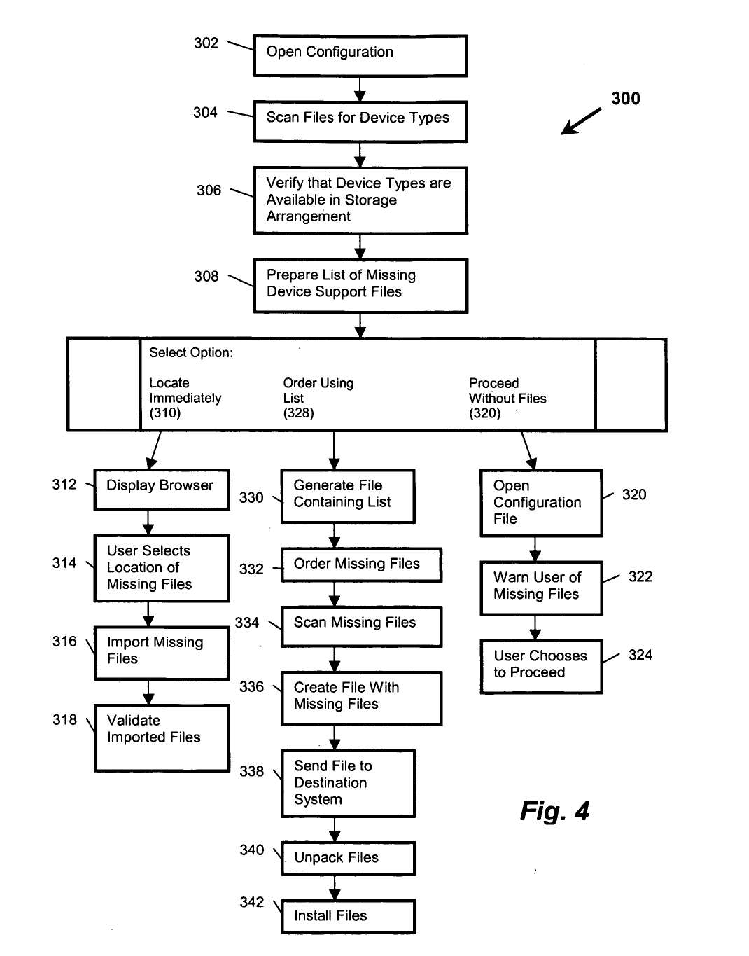

FIG. 4 shows a flow diagram of another exemplary embodiment of the method according to the present invention for confirming the device support files 16 transferred between the systems 10, 30. The example of FIG. 4 is illustrated in connection with the exemplary systems 10, 30 shown in FIG. 3, in which the device support files 16 are transferred from the local system 10 to the remote system 30. During the transfer of the device support file 16, the user can open or access a configuration file of a field device application associated with the remote system 30 in step 302. In step 304 the remote system 30 can scan the configuration file to identify most or all device types used by the system 30. The system 30 verifies in step 306, that the storage arrangement 34 recorded the device support files 36 for each of the identified device types, and in step 308 generates a list of any device support files 36 missing from the storage arrangement 34.

For any missing device support files 46, three options can be presented to the user. For example, the user can immediately locate the missing device support files 46 in step sequence 310, order the missing device support files 46 from the original system 10 in step sequence 328, and/or proceed without installing the missing device support files 46 in step sequence 320.

If the user selects the option to immediately locate the missing device support files 46 in step sequence 310, the system 30 displays a file browser that allows the user to view files on the system 30 (step 312). The user then can browse through the files using the browser, and in step 314 may select a location in the system 30, or in any other system (e.g., system 10) connected to the system 30, where the missing device support files 46 can be obtained or located (e.g., a system file depository containing a set of master device support files). Files 46 selected in step 314 by the user may imported or otherwise provided to the system 30 in step 316. The imported files can then be validated in step 316.

If the user selects the option to proceed with step sequence 320 without the missing files 46, then the system 30 can open or access a configuration file in step 322, and may notify the user in step 324 of the risk of proceeding without the missing device support files 36 (e.g., the risk of coming across a device for which the device support is missing during operation). The user can then select an option to proceed without the missing files 46 in step sequence 326.

If the user selects the option to order the missing files 46 of step sequence 328, the system 30 may generate a file (42 in FIG. 3) that has the list of the missing device support files 36 (step 330). The file format of the file 42 containing the list of missing files 46 can be standardized by the system 30 and is intended to be transparent to the user in one exemplary embodiment of the present invention. The user can then obtain or order the missing files 46 from the original system (e.g., system 10 of FIG. 3) in step 332 by transmitting the file 42 containing the list to the original system 10. At the original system 10, a user (either the same user as the user of the destination system 30 or a different user) may scan the file 42 using a software or firmware application in step 334. The original system 10 can then locate the missing device support files 46, and insert or pack the missing device support files into a file 44. The file 44 containing the missing files 46 can then be sent from the original system 10 to the destination system 30 in step 338. At the destination system 30, the missing files 46 may be unpacked from the file 44, and installed or otherwise provided in the storage arrangement 34 (step 342). Upon the installation of the missing files 46 in step 342, the missing device support files 46 may be validated as described herein with respect to FIG. 2.

In one exemplary embodiment of the present invention, the system 30 can compare the environments of the source and destination system 10, 30 by comparing the capabilities files and the device descriptions for a specific project. In other exemplary embodiments of the present invention, the comparison between the environments of the systems 10, 30 can be further extended to compare the overall device library containing a master library location with a remote system installation. A synchronization method may be employed to confirm content duplication and existence of tampered files. In yet another exemplary embodiment, other version management capabilities can be added or utilized for external sources, such as version control, file auditing, and content tracking which may provide certain mechanisms to integrate new field devices and track changes in the system 30.

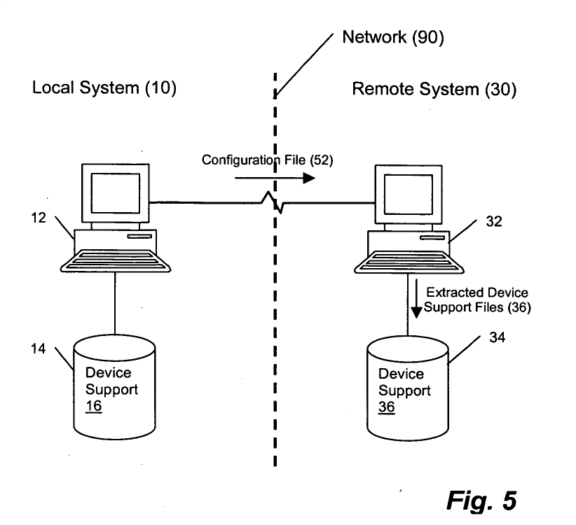

FIG. 5 shows a block diagram of still another exemplary embodiment of two interconnected computer systems 10, 30 according to the present invention. For example, the device support files 16 and 36 can be transferred between the systems 10, 30. In the example of FIG. 5, the local system 10 is the source system, and the remote system 30 is the destination system. The device support file 36 is transmitted from the local system 10 to the remote system 30. In the exemplary embodiment shown in FIG. 5, all device support files 16 associated with the configuration are packed or otherwise provided directly into a configuration file 50 transmitted from the local system 10 to the remote system 30. The configuration file 50 may be a compressed file. At the destination system 30, the device support files 36 can be extracted from the configuration file 50, and stored in the storage arrangement 34.

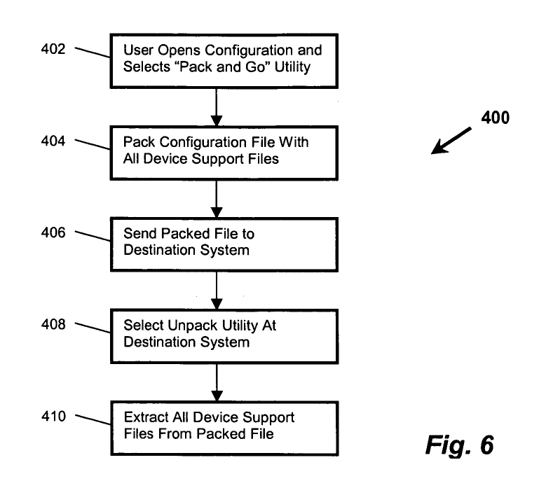

FIG. 6 shows a flow diagram of yet another exemplary embodiment of a method 400 according to the present invention for processing the device support files 36 transmitted from the source system 10 to the destination system 30, as shown in FIG. 5. At the source system 10, a user can open or obtain a configuration file or otherwise provide and select a “pack and go” software utility (step 402). The source system 10 can pack or otherwise provide the configuration file with all device support files 36 currently used by the configuration (step 404). In one exemplary embodiment, user preferences can be used to allow or enable the user to optionally select a file compactor to compress the packed files. The user then transmits the configuration file to the destination system 30 in step 406. At the destination system 30, a user (either the same user of the source system 10 or a different user) may select an “unpack and uninstall” software utility to process the received configuration file (step 408). In step 410, the destination system 30 unpacks most or all device support files 36 stored in the configuration file, and proceeds to extract the device support files 36 from the configuration file. The device support files 36 may then be installed in the storage arrangement 34 and validated, as described herein.

Although the present invention has been described with respect to particular embodiments thereof, variations are possible. The present invention may be embodied in specific forms without departing from the essential spirit or attributes thereof. For example, although the present invention is described with respect to embodiments using a Foundation™ Fieldbus environment, one skilled in the art will recognize that the present invention may be extended to any system that uses device support files to provide information to a device. Other exemplary systems may include, without limitation, HART devices protocol, EDDL and GSD files in a PROFIBUS® system or other proprietary systems. Further, the present invention may be extended to operate and/or be integrated with device components such as DTM that are based on the FDT/DTM technology, in which components, rather than files, provide the device support, and those components can be also validated according to consistency and interoperability rules by following specific standard and protocols. In another exemplary embodiment of the present invention, installation, validation, and ordering may be extended for components and verification, packing, and unpacking may be extended for FDT/DTM applications. Further, the present invention may be utilized to future standards supported by other description methods, such as OPC, XML schemas, scripting languages, web-services and other web-based standards.

In addition, although aspects of an implementation consistent with the present invention are described as being stored in a storage, one skilled in the art will appreciate that these aspects can also be store provided on or read from other types of computer program products or computer-readable media, such as secondary storage devices, including hard disks, floppy disks, or CD-ROM, a carrier wave from the Internet or other network, and/or other forms of RAM or read-only memory (ROM), and/or possibly Field Devices with storage and network management capabilities. It should also be understood that the techniques and methods described herein can be implemented using one or more software applications that are executed on one or more processing arrangements (e.g., a computer, such as a Pentium® based personal computer, minicomputer, workstation, mainframe, etc.). It is desired that the embodiments described herein be considered in all respects illustrative and not restrictive and that reference be made to the appended claims and their equivalents for determining the scope of the invention.

What is claimed is:

1. A method for processing a device support information for a field device, comprising:
a) providing a device support information to a processing arrangement, the device support information including a file that indicates capabilities of the field device; and
b) upon a receipt of the device support information at the processing arrangement, at least one of confirming or validating the device support information by comparing first data of the file with previously-obtained second data corresponding to rules associated with the file.

2. The method of claim 1, further comprising receiving the device support information from a further processing arrangement.

3. The method of claim 2, wherein the receiving step comprises prompting a user to provide a file location for the device support information, and receiving the file location selection in response from an entry by the user.

4. The method of claim 3, wherein the receiving step further comprises displaying available device support information associated with the file location.

5. The method of claim 1, wherein step (b) comprises retrieving at least one of a first code of a manufacturer or a second code of a device type from the file, and comparing the at least one of the first code or the second code with the previously-obtained rules.

6. The method of claim 1, further comprising providing a data structure in a storage arrangement of the processing arrangement, and forwarding the device support information to the storage arrangement to be stored in a format of the data structure based upon results of step (b).

7. The method of claim 6, wherein the step of providing the data structure comprises creating the data structure having a standardized format.

8. The method of claim 1, wherein step (b) comprises performing a consistency check of the file with a current version of the previously-obtained rules.

9. The method of claim 1, further comprising retrieving all available device support information for devices associated with the processing arrangement and a configuration file.

10. The method of claim 1, further comprising accessing a configuration file associated with the device support information.

11. The method of claim 10, wherein step (b) further comprise the configuration file for types of devices associated with the processing arrangement.

12. The method of claim 11, wherein step (b) comprises verifying that the device support files for the types of the devices are available in a storage arrangement associated with the processing arrangement.

13. The method of claim 1, further comprising generating a list of missing device support information based on a result of step (b) that indicates that the particular device support file types are absent.

14. The method of claim 13, further comprising prompting a user to provide instructions to at least one of immediately locate missing files, obtain the missing files, or obtain from ordering the missing files.

15. The method of claim 13, further comprising ordering the missing files based on a provided list.

16. The method of claim 13, further comprising ordering the missing files from a further processing arrangement.

17. The method of claim 13, further comprising generating a further file containing a list of the missing device support files, and ordering the missing device support files using the further file containing the list.

18. The method of claim 13, wherein step (b) comprises extracting the missing files from a further file containing the missing files received from a further processing arrangement, and installing the missing files on the processing arrangement.

19. The method of claim 1, further comprising:
displaying identifiers of the missing device support files on a graphical user interface;
receiving a selection of at least one of the displayed missing device support files; and
at least one of mining, filtering potential options or importing the selected at least one of the displayed missing device support files from a further processing arrangement.

20. The method of claim 1, further comprising obtaining a configuration file that includes the device support information.

21. A computer system comprising:
a storage arrangement having stored thereon computer-executable instructions for processing a device support information for a field device, wherein, when the instructions are executed by a processor, the following procedures are performed:
providing the device support information on a processing arrangement, the device support information including a file that indicates capabilities of the field device; and
upon a receipt of the device support information at the processing arrangement, at least one of confirming or validating the device support information by comparing first data of the file with previously-obtained second data corresponding to rules associated with the file.

22. A computer-readable medium having stored thereon computer-executable instructions for processing a device support file for a field device, wherein;
a storage arrangement having stored thereon computer-executable instructions for processing a device support information for a field device, wherein, when the instructions are executed by a processor, the following procedures are performed:
providing the device support information on a processing arrangement, the device support information including a file that indicates capabilities of the field device; and
upon a receipt of the device support information at the processing arrangement at least one of confirming or validating the device support information by comparing first data of the file with previously-obtained second data corresponding to rules associated with the file.

23. A software arrangement provided on a computer-readable medium, comprising:
first computer-executable instructions which, when executed by a processor, providing the device support information on a processing arrangement, the device support information including a file that indicates capabilities of the field device; and
second computer executable instructions which, when executed by a processor, upon a receipt of the device support information at the processing arrangement, at least one of confirming or validating the device support information by comparing first data of the file with previously-obtained second data corresponding to rules associated with the file.
